(19) United States
(12) Patent Application Publication
(10) Pub. No.: US 2026/0034017 A1
(43) Pub. Date: Feb. 5, 2026

(54) Adaptive Massager

(71) Applicant: Xiamen Ubest Electronic Technology Co., Ltd., Xiamen (CN)

(72) Inventor: Zonghu Zhu, Xiamen (CN)

(21) Appl. No.: 18/817,377

(22) Filed: Aug. 28, 2024

(30) Foreign Application Priority Data
Aug. 1, 2024 (CN) 202421852766.8

(51) Int. Cl. A61H 7/00

(52) U.S. Cl. CPC A61H 7/00; A61H 2201/0207; A61H 2201/0214; A61H 2201/0221; A61H 2201/025; A61H 2201/1671; A61H 2205/102

(57) ABSTRACT

The application relates to the field of nursing equipment, in particular to an adaptive massager, including a housing and semiconductor refrigeration plates. The housing is provided with mounting ports, a plurality of the semiconductor refrigeration plates are provided on a virtual plane enclosed by the mounting ports, the semiconductor refrigeration plate and the mounting port of the housing are movably connected, and the adjacent semiconductor refrigeration plates are movably connected to each other. A plurality of the semiconductor refrigeration plates at the mounting port are movably connected to each other, when the massager contacts the nursing parts with concave and convex profiles such as human knees, the plurality of semiconductor refrigeration plates can move a certain range to adapt to the shape of the nursing part, so as to ensure a full coverage of the nursing part and guarantee the nursing effect.

### CROSS-REFERENCE TO RELATED APPLICATIONS

This application claims priority to Chinese Patent Application No. 202421852766.8, filed on Aug. 1, 2024, the content of which is incorporated herein by reference in its entirety.

### TECHNICAL FIELD

The application relates to the field of nursing equipment, in particular to an adaptive massager.

### BACKGROUND

Existing designs of the massager generally include a housing and semiconductor refrigeration plates, etc., and nursing such as cold compress and hot compress is performed on a nursing part by operation of the semiconductor refrigeration plates on a nursing working surface of the housing. The conventional semiconductor refrigeration plates on the nursing working surface of the housing are a one-piece or multi-piece fixed setting, which often cannot cover irregular human nursing parts such as knees, resulting in a decrease in nursing effect.

### SUMMARY

A technical problem to be solved by the application is to provide an adaptive massager capable of carrying out effective nursing for human nursing parts with irregular surfaces such as knees.

In order to solve the above technical problem, the application adopts the following technical solution: an adaptive massager including a housing and semiconductor refrigeration plates, the housing is provided with mounting ports, a plurality of semiconductor refrigeration plates are provided on a virtual plane enclosed by the mounting ports, the semiconductor refrigeration plates and the mounting ports of the housing are movably connected, and the adjacent semiconductor refrigeration plates are movably connected to each other.

Further, elastic connecting members are also included, the semiconductor refrigeration plates and the mounting ports of the housing are connected by the elastic connecting members, and the adjacent semiconductor refrigeration plates are connected by the elastic connecting members.

Further, the elastic connecting members are silicone members.

Further, rotating members are also included, the semiconductor refrigeration plates and the mounting ports of the housing are connected by the rotating members, and the adjacent semiconductor refrigeration plates are connected by the rotating members.

Further, heat dissipation members are also included, a plurality of the heat dissipation members are provided in the housing, and the heat dissipation members are connected to the semiconductor refrigeration plates in one-to-one correspondence.

Further, a fan is also included, an opposite surface of a side of the housing and the heat dissipation members away from the semiconductor refrigeration plates is provided with heat dissipating holes, and the fan is provided between the heat dissipation holes and the heat dissipation members; the housing is provided with air outlets on a side surface.

Further, limiting brackets are also included, a plurality of the heat dissipation members are combined to form a heat dissipation structure, and the limiting brackets are arranged around the heat dissipation structure; a movable gap is left between the limiting brackets and the heat dissipation structure.

Further, an elastic recovery member is also included, and the elastic recovery member is connected between the housing and the semiconductor refrigeration plates.

Further, circuit boards are also included, and the circuit boards are provided between the limiting brackets and the side walls of the housing.

Further, the housing includes an upper housing and a lower housing, and the upper housing and the lower housing are detachably connected.

The application has the following beneficial effect: a plurality of the semiconductor refrigeration plates at the mounting ports are movably connected to each other, when the massager contacts the nursing parts with concave and convex profiles such as human knees, the plurality of semiconductor refrigeration plates can move a certain range to adapt to the shape of the nursing part, so as to ensure a full coverage of the nursing part and guarantee the nursing effect.

### BRIEF DESCRIPTION OF THE DRAWINGS

FIG. 1 is a schematic structural diagram of an adaptive massager according to an embodiment of the application in an unused state;

FIG. 2 is a schematic structural diagram of an adaptive massager according to an embodiment of the application in a state in which the adaptive massager is in contact with a nursing part;

FIG. 3 is a sectional view of an adaptive massager according to an embodiment of the application in an unused state; and

FIG. 4 is a sectional view of an adaptive massager according to an embodiment of the application in a state in which the adaptive massager is in contact with a nursing part;

### REFERENCE NUMERALS

1: housing; 11: upper housing; 12: lower housing; 13: mounting port; 14: heat dissipation hole; 15: air outlet; 2: semiconductor refrigeration plate; 3: elastic connecting member; 4: heat dissipation member; 5: fan; 6: limiting bracket; 7: circuit board; 8: elastic recovery member.

### DETAILED DESCRIPTION OF THE EMBODIMENTS

In order to explain the technical content, object, and effect of the application in detail, embodiments will be described below with reference to the drawings.

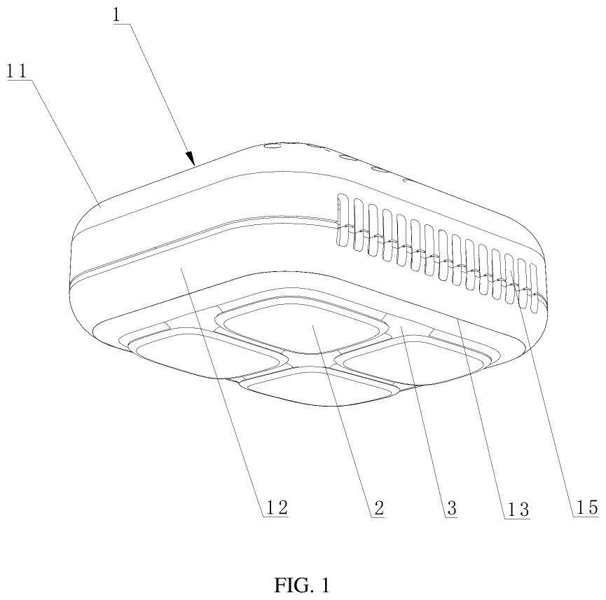

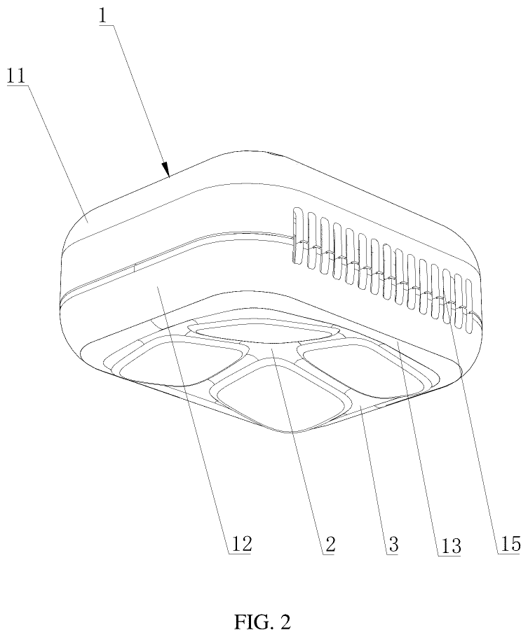

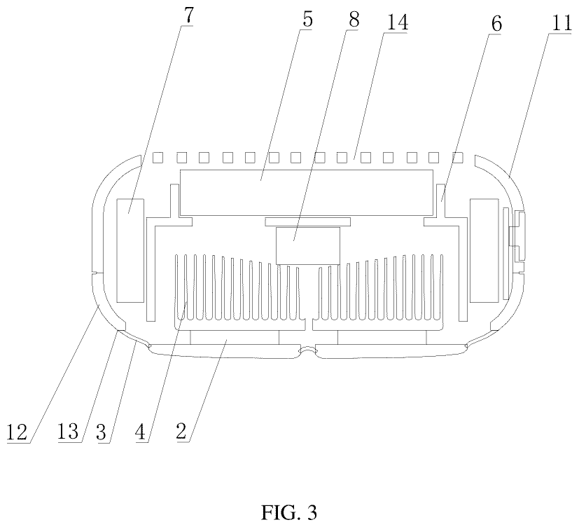

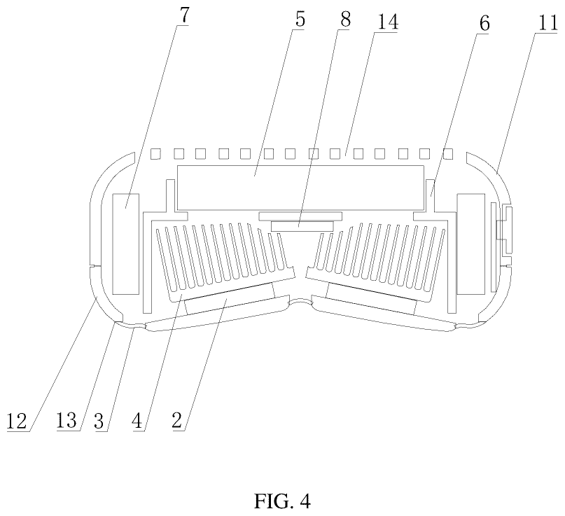

Referring to FIGS. 1 to 4, an adaptive massager includes a housing 1 and semiconductor refrigeration plates 2, the housing 1 is provided with mounting ports 13, a plurality of the semiconductor refrigeration plates 2 are provided on a virtual plane enclosed by the mounting ports 13, the semiconductor refrigeration plates 2 and the mounting ports 13 of the housing 1 are movably connected, and the adjacent semiconductor refrigeration plates 2 are movably connected to each other.

From the above description, it can be seen that the application has the following beneficial effect: a plurality of the semiconductor refrigeration plates 2 at the mounting ports 13 are movably connected to each other, when the massager contacts the nursing parts with concave and convex profiles such as human knees, the plurality of semiconductor refrigeration plates 2 can move a certain range to adapt to the shape of the nursing part, so as to ensure a full coverage of the nursing part and guarantee the nursing effect.

Further, elastic connecting members 3 are also included, the semiconductor refrigeration plates 2 and the mounting ports 13 of the housing 1 are connected by the elastic connecting members 3, and the adjacent semiconductor refrigeration plates 2 are connected by the elastic connecting members 3.

From the above description, it can be seen that the elastic connecting members 3 are used to realize the movable connection between the semiconductor refrigeration plates 2 and the housing 1, and between the adjacent semiconductor refrigeration plates 2.

Further, the elastic connecting members 3 are silicone members.

From the above description, it can be seen that, specifically, the elastic connecting members 3 can adopt the silicone members as a connecting structure, and the silicone members are connected to the mounting ports 13 of the housing 1, and the semiconductor refrigeration plates 2 are arranged on the silicone members; the elastic deformation of the silicone members after being stressed is used to adapt to the nursing part.

Further, rotating members are also included, the semiconductor refrigeration plates 2 and the mounting ports 13 of the housing 1 are connected by the rotating members, and the adjacent semiconductor refrigeration plates 2 are connected by the rotating members.

From the above description, it can be seen that, according to the actual design and the requirements of the usage scenario, rotating members with a mechanical structure can be adopted, which can also realize the movable connection between the semiconductor refrigeration plates 2 and the housing 1 and between the adjacent semiconductor refrigeration plates 2.

Further, heat dissipation members 4 are also included, a plurality of the heat dissipation members 4 are provided in the housing 1, and the heat dissipation members 4 are connected to the semiconductor refrigeration plates 2 in one-to-one correspondence.

From the above description, it can be seen that the working heat of the semiconductor refrigeration plates 2 can be conducted to the outside through the heat dissipation members 4, so as to avoid affecting its working state and nursing effect.

Further, a fan 5 is also included, an opposite surface of a side of the housing 1 and the heat dissipation members 4 away from the semiconductor refrigeration plates 2 is provided with heat dissipation holes 14, and the fan 5 is provided between the heat dissipation holes 14 and the heat dissipation members 4; the housing 1 is provided with air outlets 15 on a side surface.

From the above description, it can be seen that the active heat dissipation of the fan 5 combined with the heat dissipation member 4 can bring the working heat of the semiconductor refrigeration plates 2 out of the housing 1 through a ventilation channel of the heat dissipation holes 14 and the air outlets 15.

Further, limiting brackets 6 are also included, a plurality of the heat dissipation members 4 are combined to form a heat dissipation structure, and the limiting brackets 6 are arranged around the heat dissipation structure; a movable gap is left between the limiting brackets 6 and the heat dissipation structure.

From the above description, it can be seen that the movable range of the semiconductor refrigeration plates 2 and the heat dissipation members 4 are limited by the design of the movable gap between the limiting brackets 6 and the heat dissipation structure.

Further, an elastic recovery member 8 is also included, and the elastic recovery member 8 is connected between the housing 1 and the semiconductor refrigeration plates 2.

From the above description, it can be seen that the design of the elastic recovery member 8 can ensure that the mounting surface of the housing 1 deformed due to the shape adaptation of the nursing part can maintain the pressure contact with the nursing part under the elastic recovery force of the elastic recovery member 8, so as to ensure the nursing effect.

Further, circuit boards 7 are also included, and the circuit boards 7 are provided between the limiting brackets 6 and the side walls of the housing 1.

From the above description, it can be seen that the spaces between the limiting brackets 6 and the side wall of the housing 1 are used as mounting spaces of the circuit boards 7, the arrangement of the inner space of the housing 1 is reasonably planned, and at the same time, the heat emitted by the heat dissipation members 4 is isolated by the limiting brackets 6, so as to avoid the influence thereof on the circuit boards 7.

Further, the housing 1 includes an upper housing 11 and a lower housing 12, and the upper housing 11 and the lower housing 12 are detachably connected.

From the above description, it can be seen that the detachable connection design of the upper housing 11 and the lower housing 12 is convenient for maintenance and assembly.

### Embodiment I

Application scenario: existing designs of the massager generally include a housing 1 and semiconductor refrigeration plates 2, etc., and nursing such as cold compress and hot compress is performed on a nursing part by operation of the semiconductor refrigeration plates 2 on a nursing working surface of the housing 1. The conventional semiconductor refrigeration plates 2 on the nursing working surface of the housing 1 are a one-piece or multi-piece fixed setting, which often cannot cover irregular human nursing parts such as knees, resulting in a decrease in nursing effect.

As shown in FIGS. 1 to 4, the adaptable massager of the embodiment includes a housing 1, semiconductor refrigeration plates 2, heat dissipation members 4, limiting brackets 6, an elastic recovery member 8, a fan 5, and circuit boards 7.

The housing 1 is spliced together by an upper housing 11 and a lower housing 12, the housing 1 is provided with air outlets 15 on a side surface, the upper housing 11 is provided with heat dissipation holes 14, the lower housing 12 is provided with mounting ports 13, a plurality of the semiconductor refrigeration plates 2 are provided on a virtual plane enclosed by the mounting ports 13, and the number of the semiconductor refrigeration plates 2 can be arranged according to actual needs. In the embodiment, four semiconductor refrigeration plates 2 are adopted. The semiconductor refrigeration plates 2 and the mounting ports 13 of the housing 1 are movably connected, and the adjacent semiconductor refrigeration plates 2 are movably connected to each other. Specifically, in the embodiment, silicone members are used to realize the above movable connection between the semiconductor refrigeration plates 2 and the mounting ports 13 of the housing 1 and between the adjacent semiconductor refrigeration plates 2, which can be adjusted adaptively according to the shape of the nursing part. In other embodiments, rotating members of mechanical structure may also be used to realize the movable connection; optionally, the semiconductor refrigeration plates 2 are connected with thermal conductive blocks, the thermal conductive blocks and the mounting ports 13 of the housing 1 are movably connected, and the adjacent thermal conductive blocks are also movably connected to each other.

A fan 5, limiting brackets 6, heat dissipation members 4 and semiconductor refrigeration plates 2 are successively arranged between the upper housing 11 and the lower housing 12. A side of the semiconductor refrigeration plates 2 away the mounting ports 13 is connected in one-to-one correspondence with one heat dissipation member 4, and a surface of the heat dissipation members 4 away from the semiconductor refrigeration plates 2 is provided with a plurality of heat dissipation fins. The limiting brackets 6 are fixedly connected in the housing 1, the limiting brackets 6 are frame-shaped structures, which enclosing the heat dissipation structure formed by a plurality of the heat dissipation members 4 and leaving a movable gap for limiting the deformation range of the heat dissipation members 4 and semiconductor refrigerants. The limiting brackets 6 are provided with an elastic recovery member 8 in the middle part, and the elastic recovery member 8 is connected to the limiting brackets 6 and a plurality of the heat dissipation members 4. A side of the limiting brackets 6 away from the heat dissipation members 4 is provided with a mounting groove for mounting the fan 5. The circuit boards 7 are arranged at the space between the two sides of the limiting brackets 6 and the inside of the housing 1, and correspondingly, structures such as operation buttons or operation screens connected with the circuit boards 7 are provided on a side surface of the housing 1.

To sum up, the adaptive massager provided in the application adopts a movable connection design of a plurality of the semiconductor refrigeration plates at the mounting ports, when the massager contacts the nursing parts with concave and convex profiles such as human knees, the plurality of semiconductor refrigeration plates can move a certain range to adapt to the shape of the nursing part, so as to ensure a full coverage of the nursing part and guarantee the nursing effect.

The above description is merely embodiments of the application, and do not limit the patent scope of the application. Any equivalent transformation made using the content of the description and drawings of the application, directly or indirectly applied in other related technical fields, is also included in the scope of protection of the application.

1. An adaptive massager, comprising a housing and semiconductor refrigeration plates, wherein the housing is provided with mounting ports, a plurality of the semiconductor refrigeration plates are provided on a virtual plane enclosed by the mounting ports, the semiconductor refrigeration plates and the mounting ports of the housing are movably connected, and the adjacent semiconductor refrigeration plates are movably connected to each other.

2. The adaptive massager according to claim 1, further comprising elastic connecting members, wherein the semiconductor refrigeration plates and the mounting ports of the housing are connected by the elastic connecting members, and the adjacent semiconductor refrigeration plates are connected by the elastic connecting members.

3. The adaptive massager according to claim 2, wherein the elastic connecting members are silicone members.

4. The adaptive massager according to claim 1, further comprising rotating members, wherein the semiconductor refrigeration plates and the mounting ports of the housing are connected by the rotating members, and the adjacent semiconductor refrigeration plates are connected by the rotating members.

5. The adaptive massager according to claim 1, further comprising heat dissipation members, wherein a plurality of the heat dissipation members are provided in the housing, and the heat dissipation members are connected to the semiconductor refrigeration plates in one-to-one correspondence.

6. The adaptive massager according to claim 5, further comprising a fan, wherein an opposite surface of a side of the housing and the heat dissipation members away from the semiconductor refrigeration plates is provided with heat dissipating holes, and the fan is provided between the heat dissipation holes and the heat dissipation members; the housing is provided with air outlets on a side surface.

7. The adaptive massager according to claim 1, further comprising limiting brackets, wherein a plurality of the heat dissipation members are combined to form a heat dissipation structure, and the limiting brackets are arranged around the heat dissipation structure; a movable gap is left between the limiting brackets and the heat dissipation structure.

8. The adaptive massager according to claim 1, further comprising an elastic recovery member, wherein the elastic recovery member is connected between the housing and the semiconductor refrigeration plates.

9. The adaptive massager according to claim 7, further comprising circuit boards, wherein the circuit boards are arranged between the limiting brackets and side walls of the housing.

10. The adaptive massager according to claim 1, wherein the housing comprises an upper housing and a lower housing, and the upper housing and the lower housing are detachably connected.
